(19) United States
(12) Patent Application Publication
(10) Pub. No.: US 2012/0096772 A1
(43) Pub. Date: Apr. 26, 2012

(54) Door System

(75) Inventor: Jay M. Francisco, Chula Vista, CA (US)

(73) Assignee: Hamilton Sundstrand Corporation, Windsor Locks, CT (US)

(21) Appl. No.: 12/911,632

(22) Filed: Oct. 25, 2010

(51) Int. Cl. E06B 3/70; E05F 11/54

(52) U.S. Cl. 49/359; 49/324; 49/358; 49/506

(57) ABSTRACT

A door system for an inlet comprises: a first door hinged to face a first direction that covers a portion of the inlet; a second door, adjacent to the first door, hinged to face a second direction opposite the first direction that covers the remainder of the inlet; and an actuator system that operates the doors in selectable door system states comprising: first door closed and second door closed; first door opened and second door closed; first door opened and second door opened; and first door closed and second door opened.

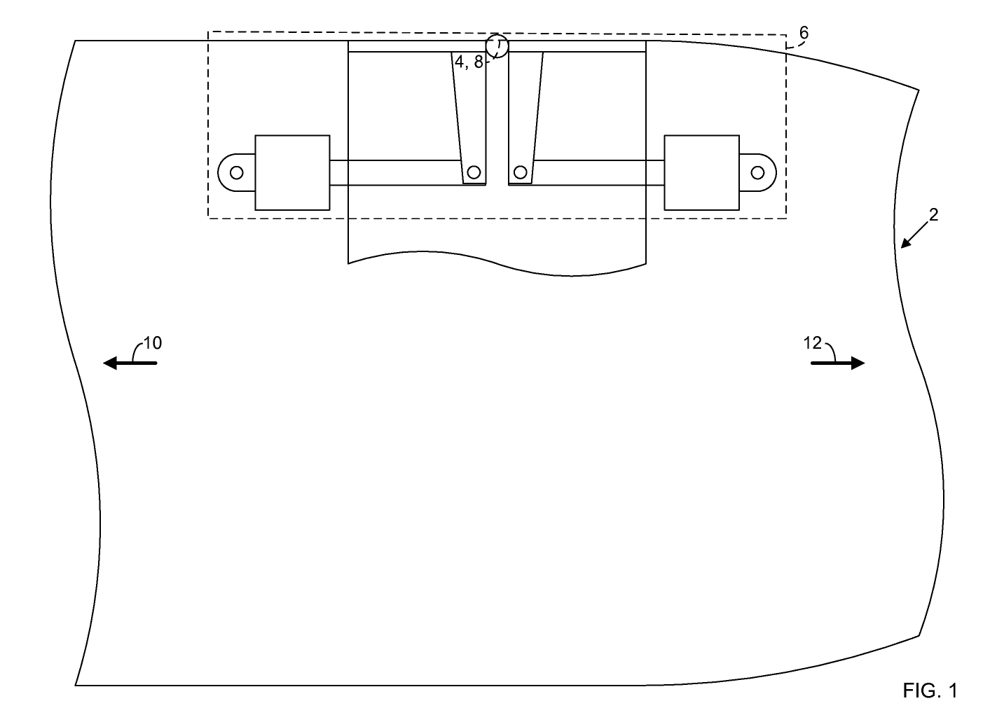

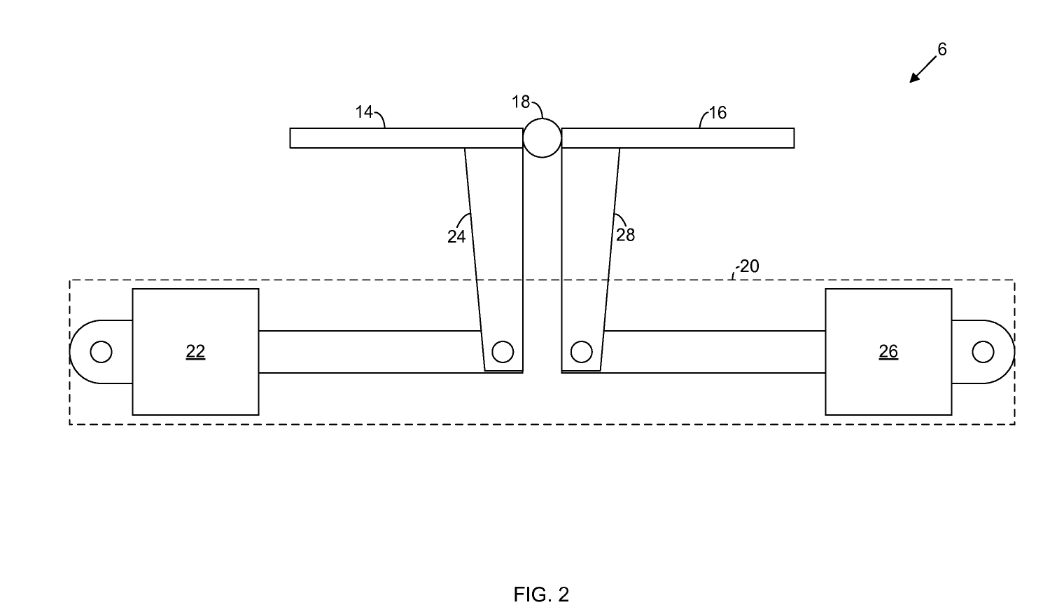

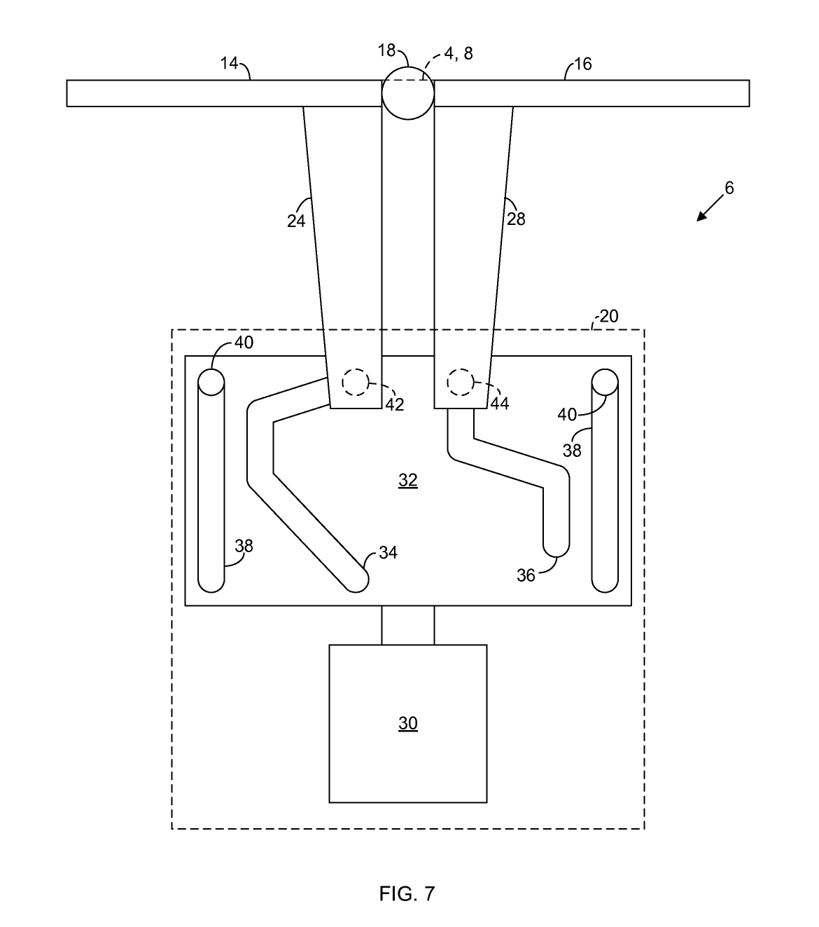

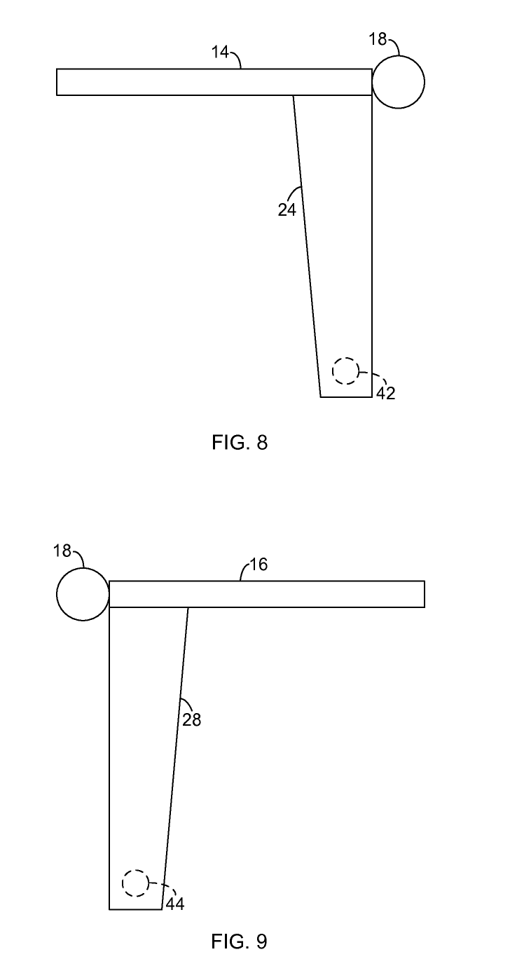

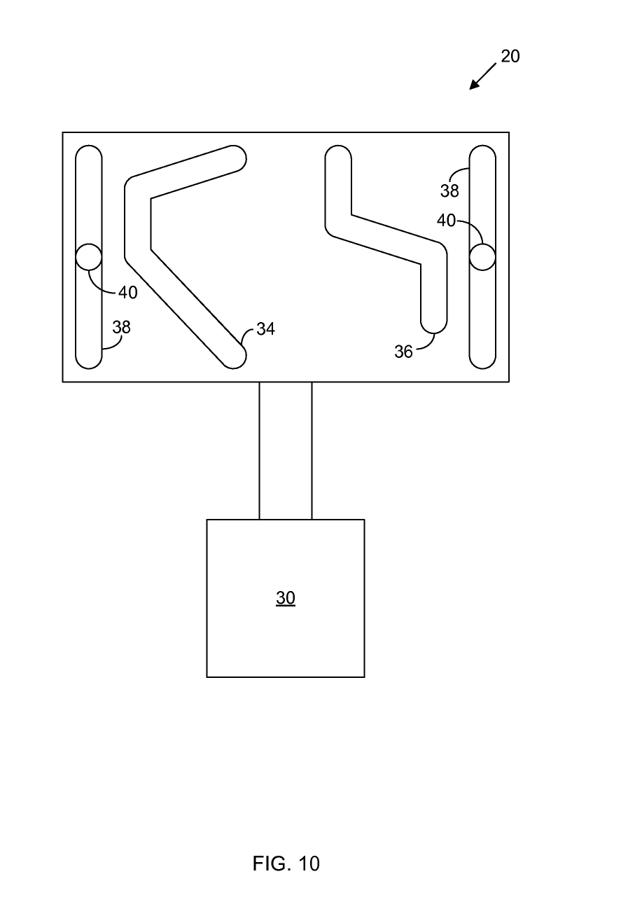

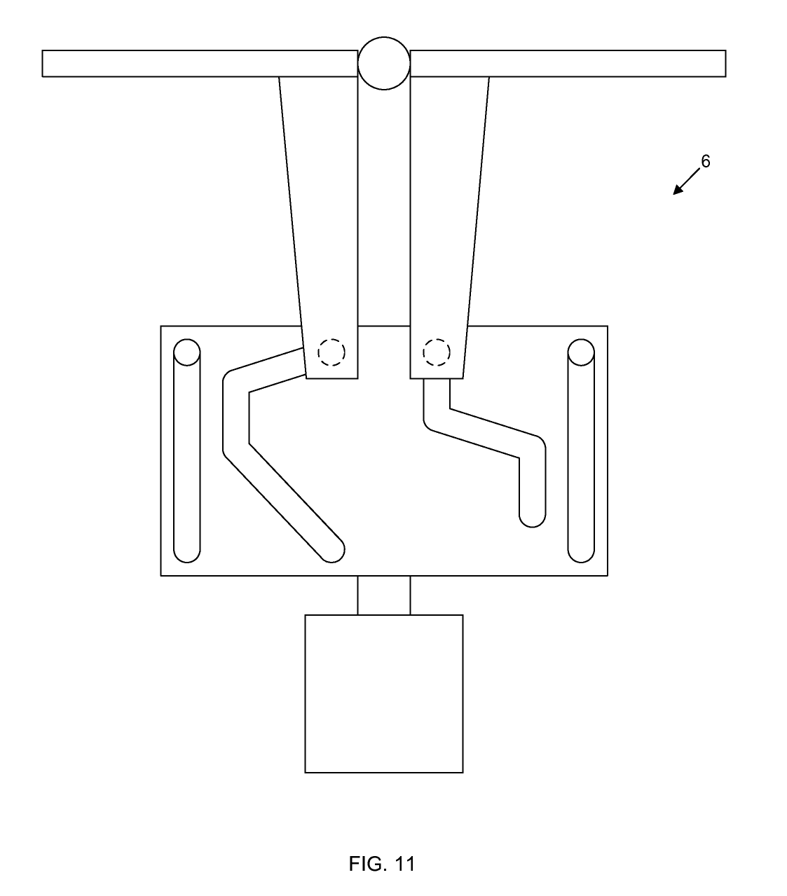

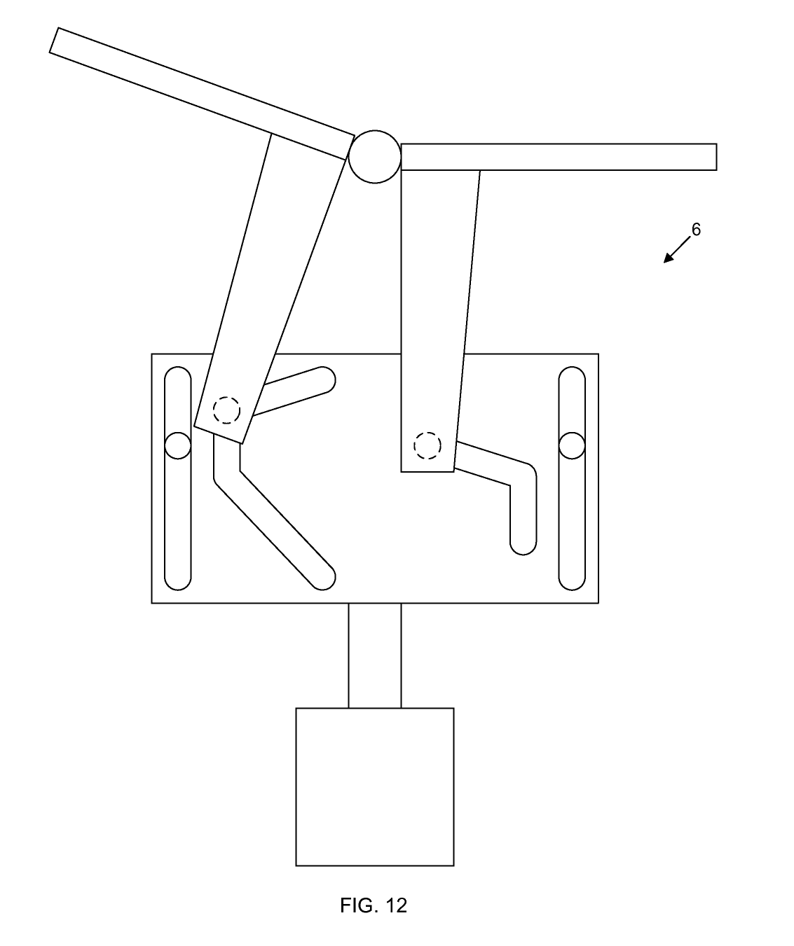

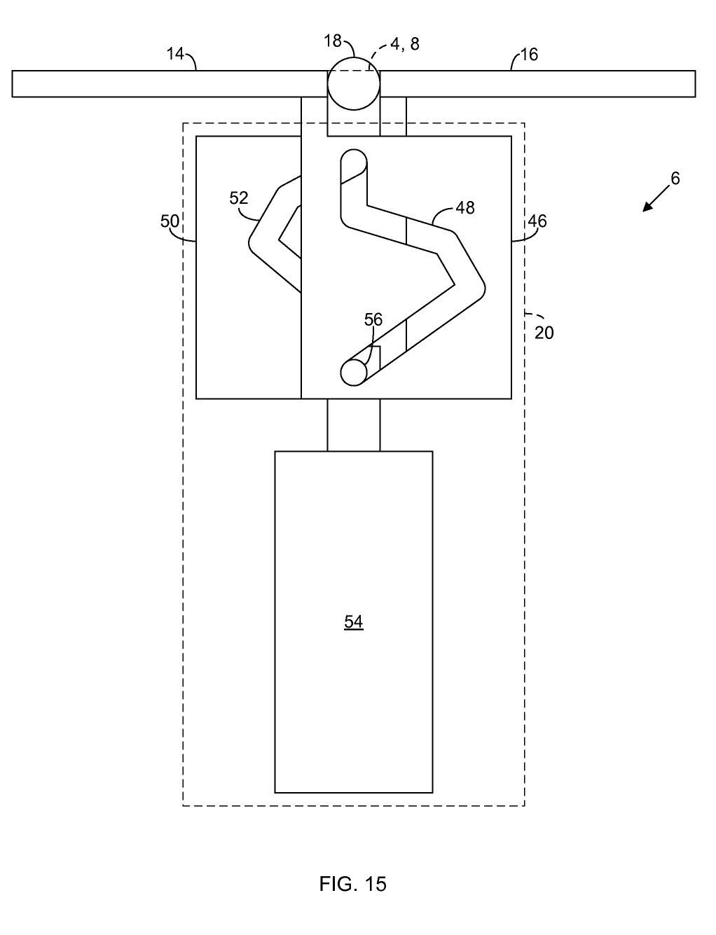

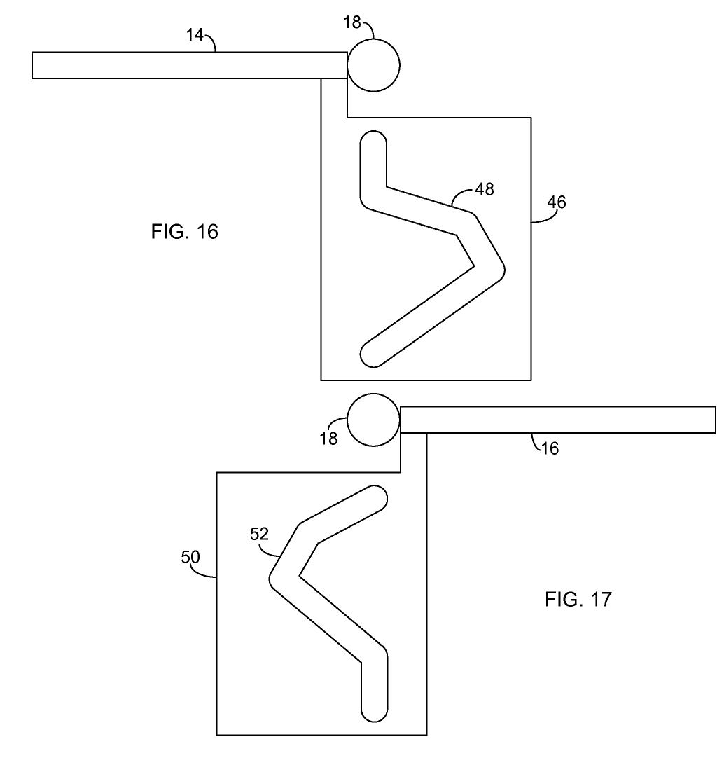

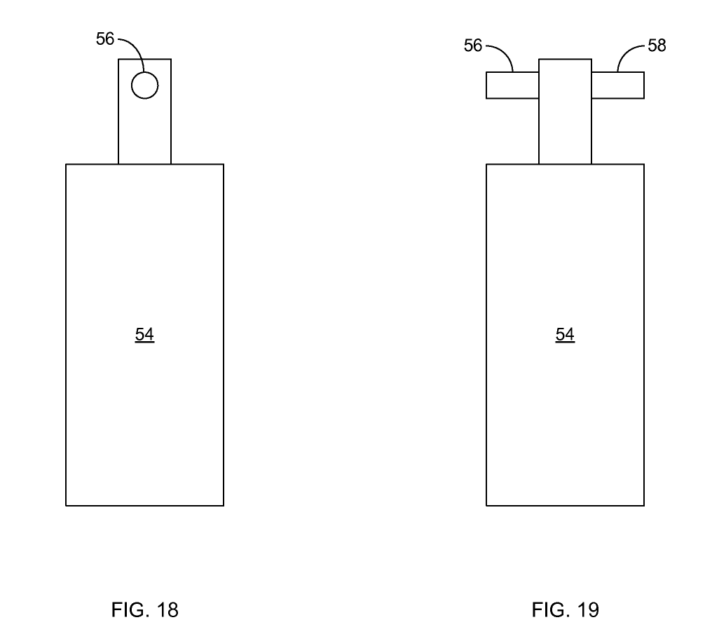

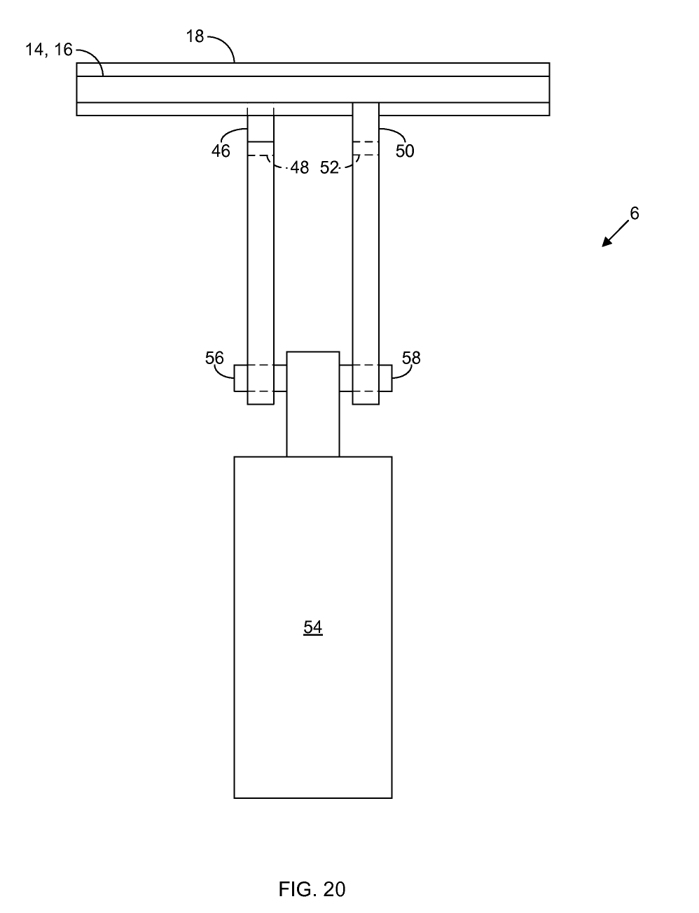

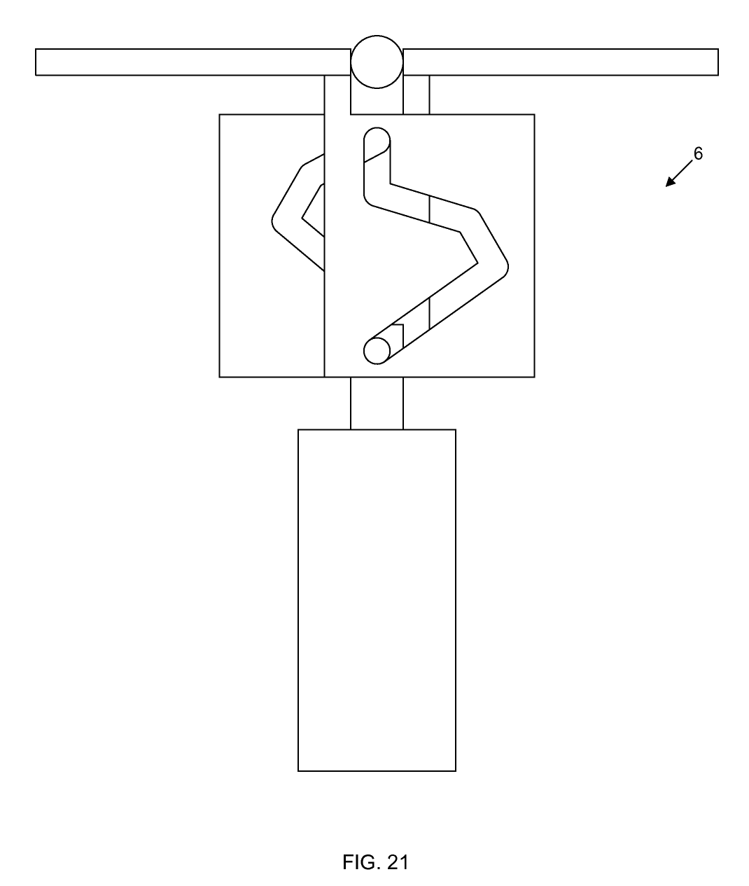

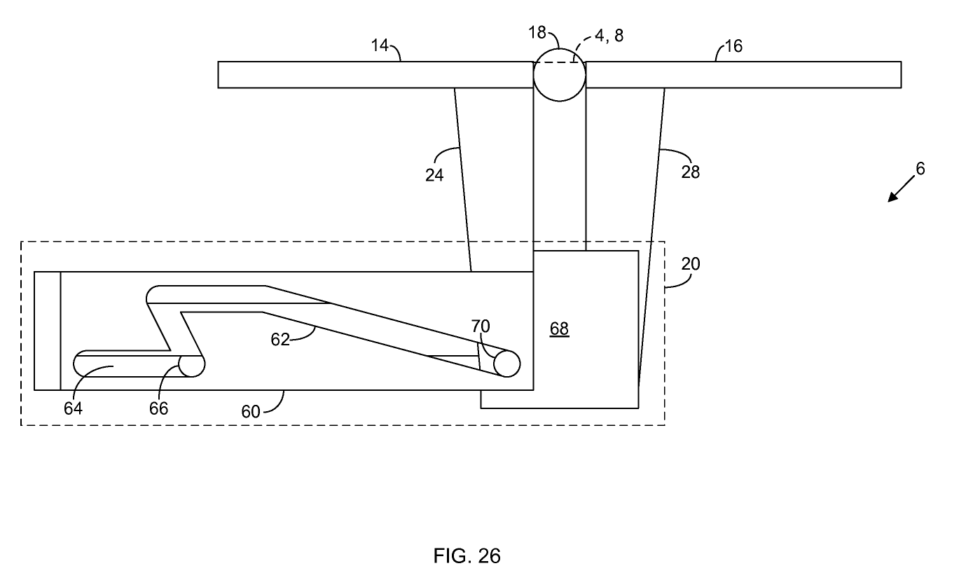

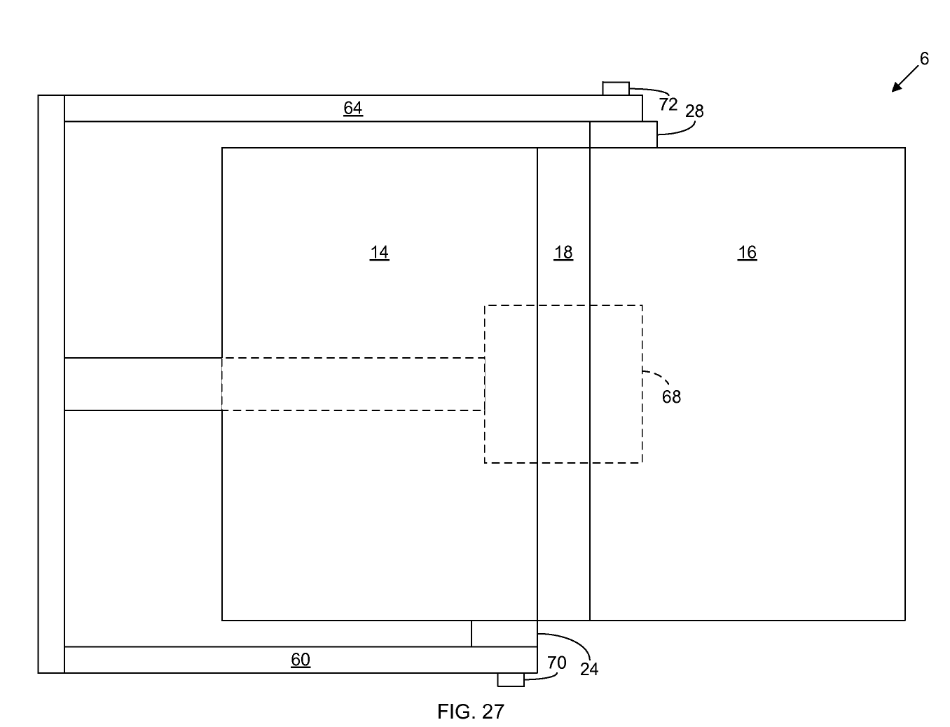

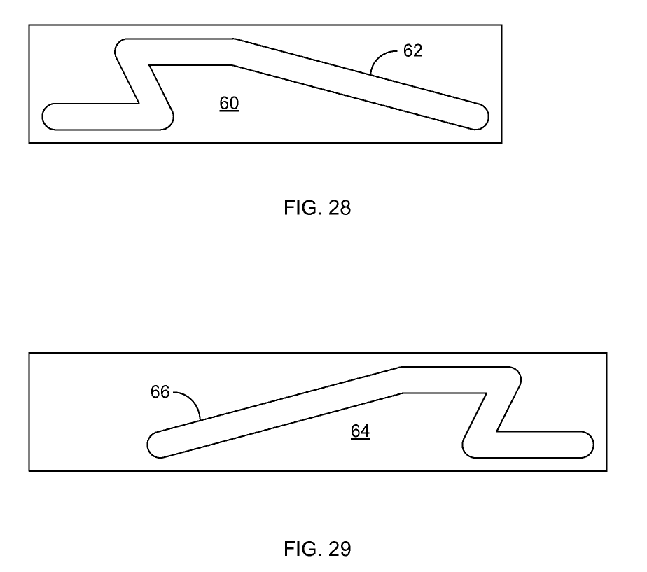

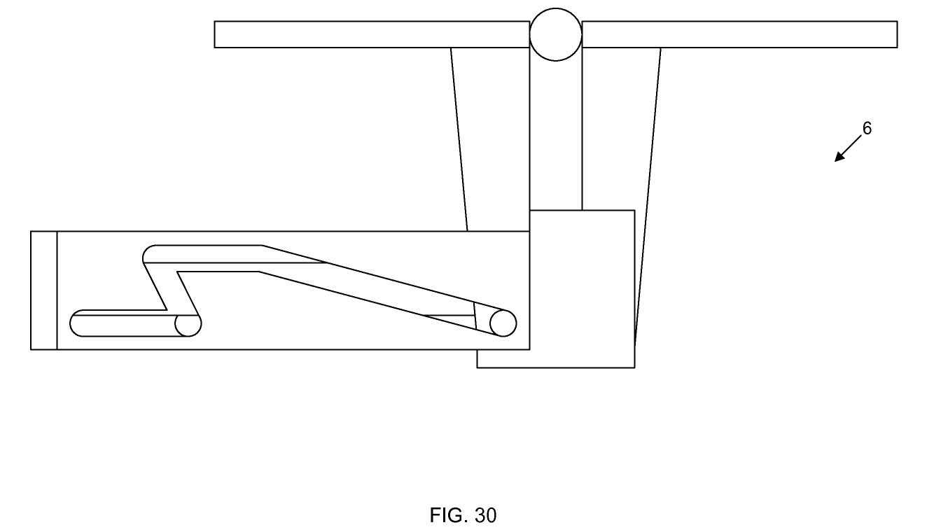

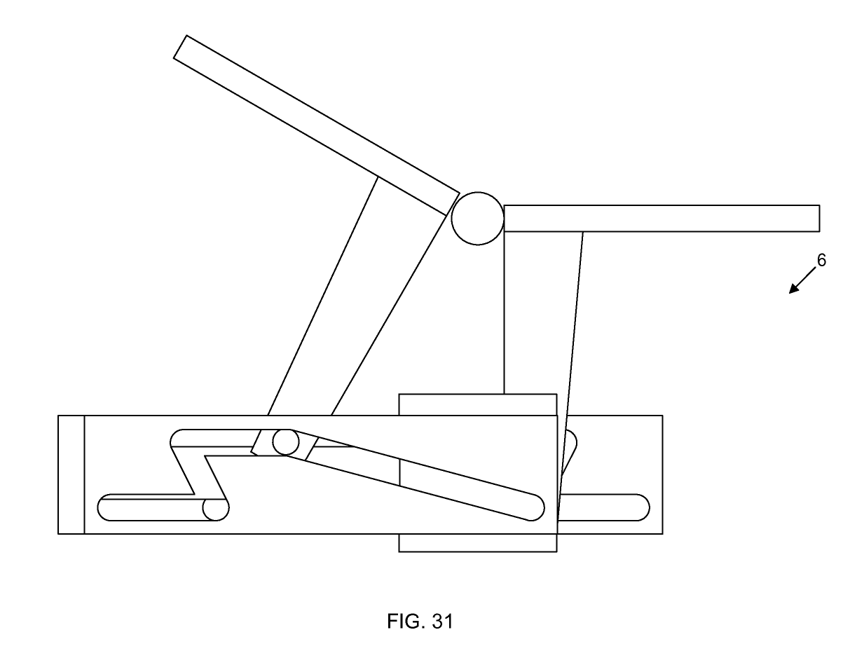

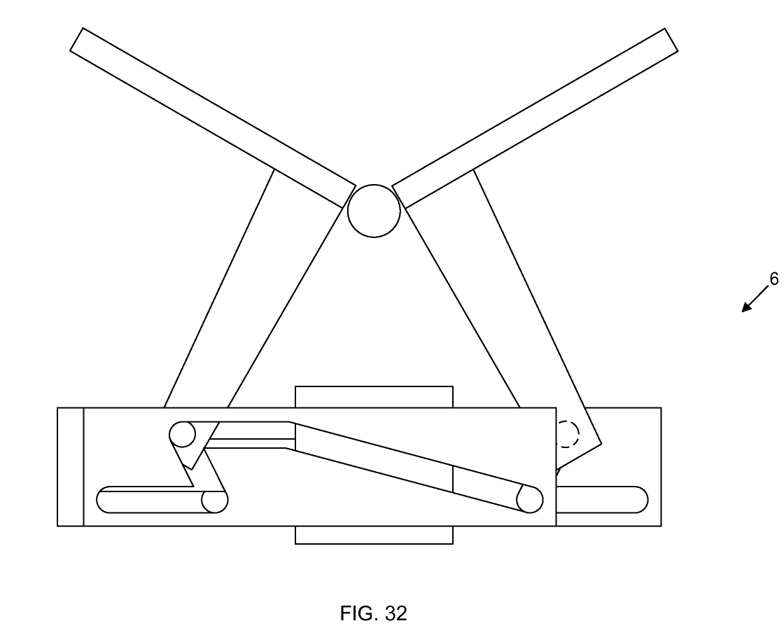

FIG. 1 is a partial cut-away side view of an aeronautical vehicle with an inlet and a door system for the inlet according to a first possible embodiment. FIGS. 2 through 6 are detailed side views of the door system according to the first possible embodiment in a successive sequence of possible door system states. FIG. 7 is a detailed side view of the door system according to a second possible embodiment. FIGS. 8 and 9 are detailed side views of first and second doors for the second possible embodiment of the door system. FIG. 10 is a detailed side view of an actuator and cam plate for the second possible embodiment of the door system. FIGS. 11 through 14 are detailed side views of the door system according to the second possible embodiment in a successive sequence of possible door system states. FIG. 15 is a detailed side view of the door system according to a third possible embodiment. FIGS. 16 and 17 are detailed side views of the first and second doors with associated cam plates for the third possible embodiment of the door system. FIGS. 18 and 19 are detailed side and end views of an actuator with associated cam followers for the third embodiment of the door system. FIG. 20 is a detailed end view of the door system according to the third possible embodiment. FIGS. 21 through 25 are detailed side views of the door system according to the third possible embodiment in a successive sequence of possible door system states. FIG. 26 is a detailed side view of the door system according to a fourth possible embodiment. FIG. 27 is a detailed top view of the door system according to the fourth possible embodiment. FIGS. 28 and 29 are detailed side view of first and second cam plates for the door system according to the fourth possible embodiment. FIGS. 30 through 34 are detailed side views of the door system according to the fourth possible embodiment in a successive sequence of possible door system states. FIGS. 31 and 32 are detailed side and top views of a fifth possible embodiment of the invention.

FIG. 1 is a partial cut-away side view of an aeronautical vehicle 2 with an inlet 4 and a door system 6 for the inlet 4 according to a first possible embodiment. The door system 6 mounts along or near a plane 8 along which the inlet 4 extends. The aeronautical vehicle 2 has a fore part represented in direction along the aeronautical vehicle 2 by an arrow 10 and an aft part represented in direction along the aeronautical vehicle 2 by an arrow 12.

FIGS. 2 through 6 are detailed side views of the door system 6 according to the first possible embodiment in a successive sequence of possible door system states. Referring to FIG. 2 through 6 together, the door system 6 has a first door 14 that covers a portion of the inlet 4 and a second door 16 that covers the remainder of the inlet 4. A hinge 18 hinges the first door 14 to face a first direction toward the fore part 10 of the aeronautical vehicle 2 and hinges the second door 16 to face a second direction opposite the first direction toward the aft part 12 of the aeronautical vehicle 2. An actuator system 20 for the first door 14 and the second door 16 operates the first door 14 and the second door 16 in selectable positions.

The actuator system 20 comprises a first actuator 22 that couples to a first door lever 24 to operate the first door 14 and a second actuator 26 that couples to a second door lever 28 to operate the second door 16. The first actuator 22 and the second actuator 26 operate generally parallel to the inlet plane 8. FIGS. 2 through 6 show a sequence of five desirable door system states in which the actuator system 20 may position the first door 14 and the second door 16. FIG. 2 represents an in-flight condition where it is desirable for the actuator system 20 to place the door system 6 in a state that has the first door 14 closed and the second door 16 closed to close the inlet 4. In this case, the first actuator 22 operates the first door 14 and the second actuator 26 operates the second door 16 to close them both. This may be a desirable state when the inlet 4 couples to an auxiliary power unit (APU) (not shown) and the APU is not in operation, to prevent windmilling of the auxiliary power unit, or for fire containment.

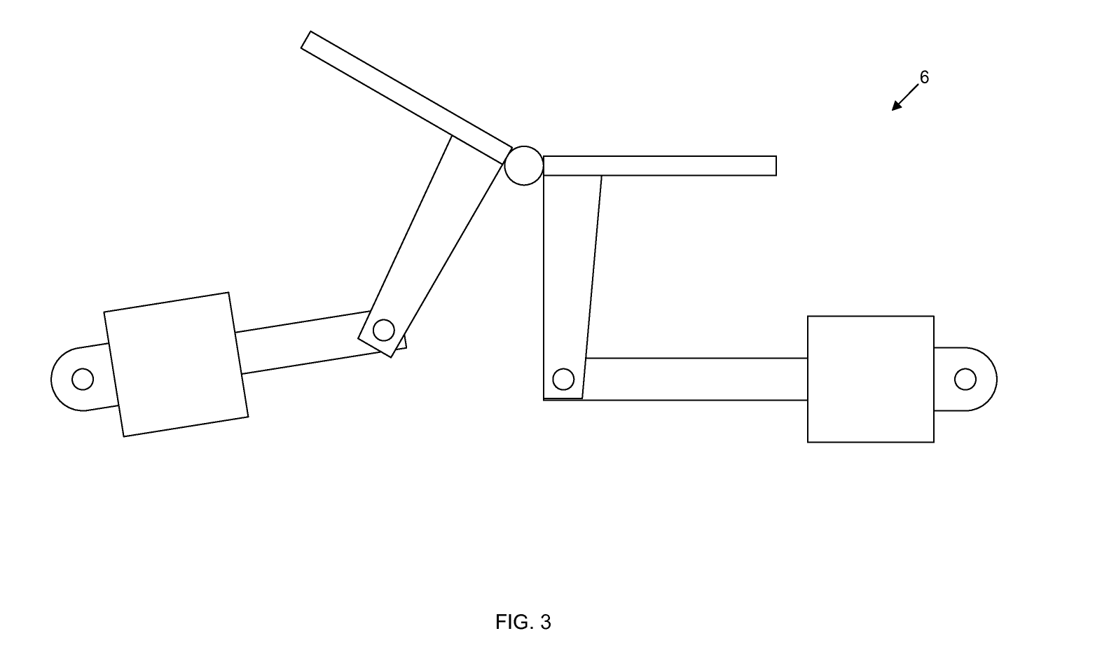

FIG. 3 represents an in-flight condition where it is desirable for the actuator system 20 to place the door system 6 in a state that has the first door 14 opened and second door 16 closed. In this case, the first actuator 22 operates the first door 14 to change its position from closed to opened and the second actuator 26 leaves the second door in the closed position. This is a desirable state when the APU is operating in flight, wherein the open first door 14 on the inlet 4 provides ram air to the APU.

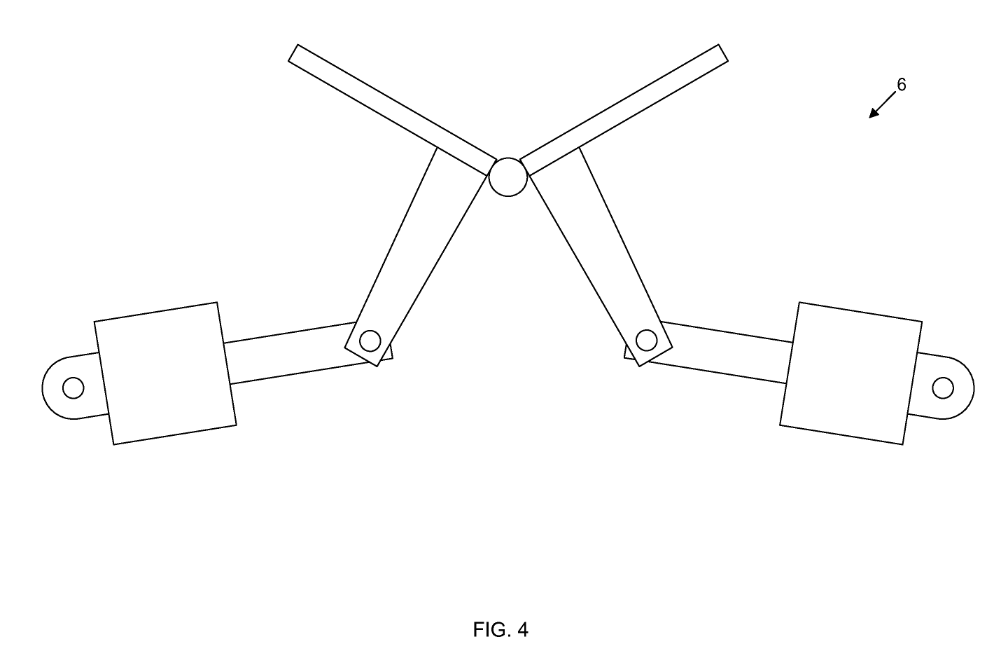

FIG. 4 represents a transition condition where it is desirable for the actuator system 20 to transition the door system 6 from a state with the first door 14 opened and the second door 16 closed to a state with the first door 14 closed and the second door 16 opened without blocking the inlet 4. In this case, the first actuator 22 leaves the first door 14 opened and the second actuator operates the second door 16 to change its position from closed to opened.

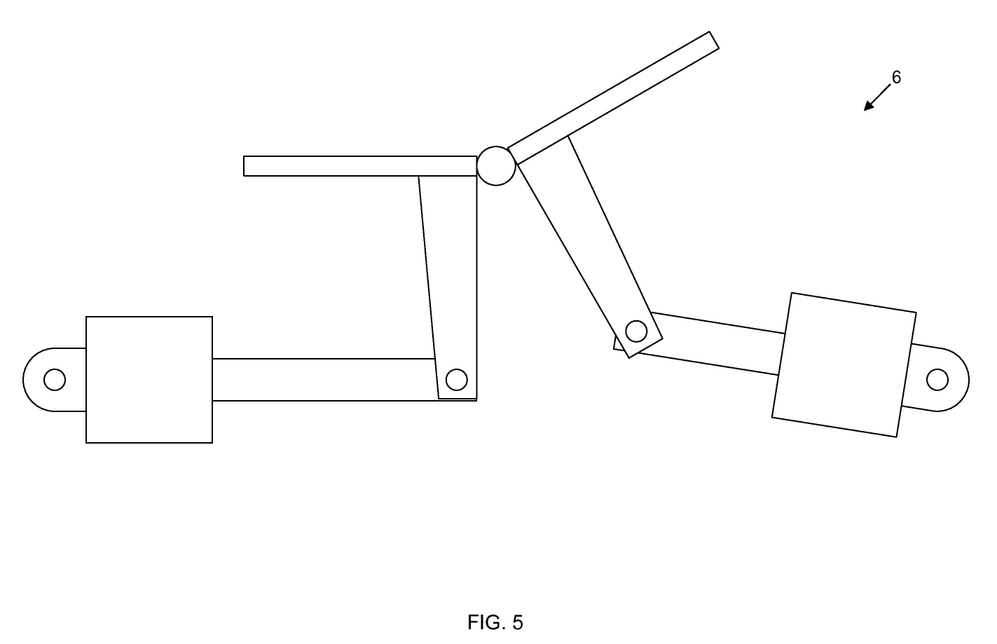

FIG. 5 represents an on-ground condition where it is desirable for the actuator system 20 to place the door system 6 in a state that has the first door 14 opened and second door 16 closed. In this case, the first actuator 22 operates the first door 14 to change its position from opened to closed and the second actuator 26 leaves the second door 16 in the opened position. This is a desirable state when the APU is operating in flight, wherein the open second door 16 on the inlet 4 provides air to the APU and its aft-facing position reduces noise transmittable from the APU to toward the passenger door or other aircraft service locations (not shown) in the aft part 10 of the aeronautical vehicle 2 whilst the aeronautical vehicle 2 sits on the ground.

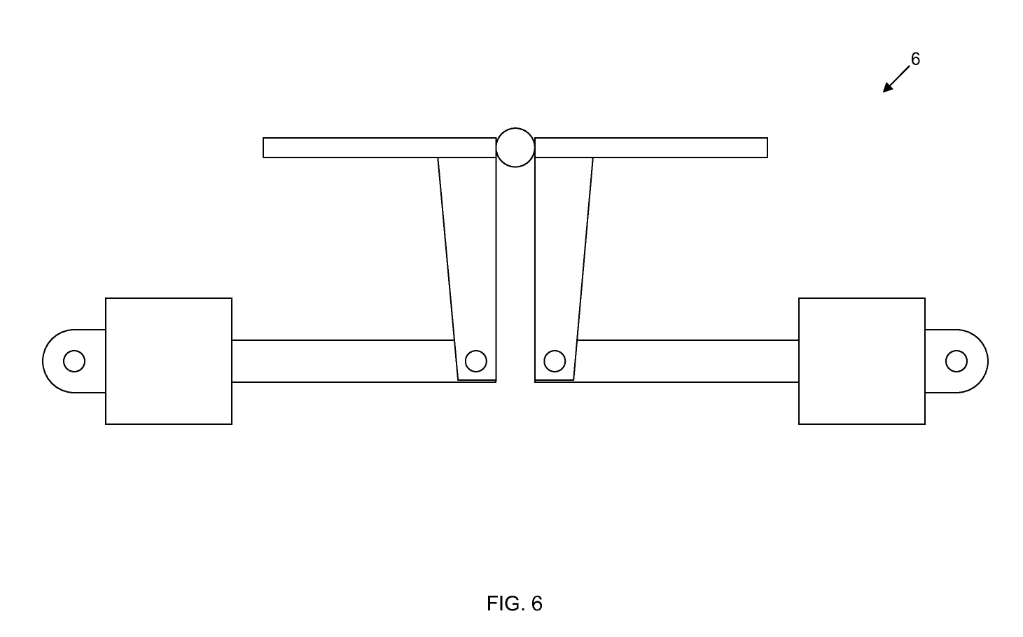

FIG. 6 represents another on-ground condition where it is desirable for the actuator system 20 to place the door system 6 in a state that has the first door 14 closed and the second door 16 closed. In this case, the first actuator 22 leaves the first door 14 in the closed position and the second actuator 26 operates the second door to change its position from opened to closed.

The first possible embodiment allows the first door 14 and the second door 16 to operate in the described sequence of states of the door system 6 as well as its reverse with a wide degree of door opening. For instance, FIGS. 2 through 6 show the first door 14 and the second door 16 sequentially opening approximately thirty degrees, and wider degrees of opening are possible. Furthermore, the operation of the first door 14 and the second door 16 may not include the entire described sequence. For example, the door system 6 may delete the second on-ground state as shown in FIG. 6. Finally, the first embodiment allows the second actuator 26 to be smaller than the first actuator 22, since force needed to open the second door 16 is less than the first door 14 in flight due to ram airflow through the first door 14.

FIG. 7 is a detailed side view of the door system 6 according to a second possible embodiment. It includes the first door 14 with its first door lever 24, the second door with its second door lever 28 and the hinge 18 that hinges the first door 14 and the second door 16 similar to the first embodiment. However, the actuator system 20 comprises a single actuator 30 that operates generally normal to the inlet plane 8 that moves a cam plate 32 coupled to the actuator 30.

Referring to FIGS. 7 and 10 together, the cam plate 32 has a first cam track 34 and a second cam track 36. The cam plate 32 may also have guide slots 38 that follow stationary guide pins 40 to add stability to the operation of the actuator system 20. Referring to FIGS. 7 and 8 together, the first door lever 24 carries a cam follower 42 that follows the first cam track 34 in the cam plate 32. Referring to FIGS. 7 and 9 together, the second door lever 28 carries a second cam follower 44 that follows the second cam track in the cam plate 32.

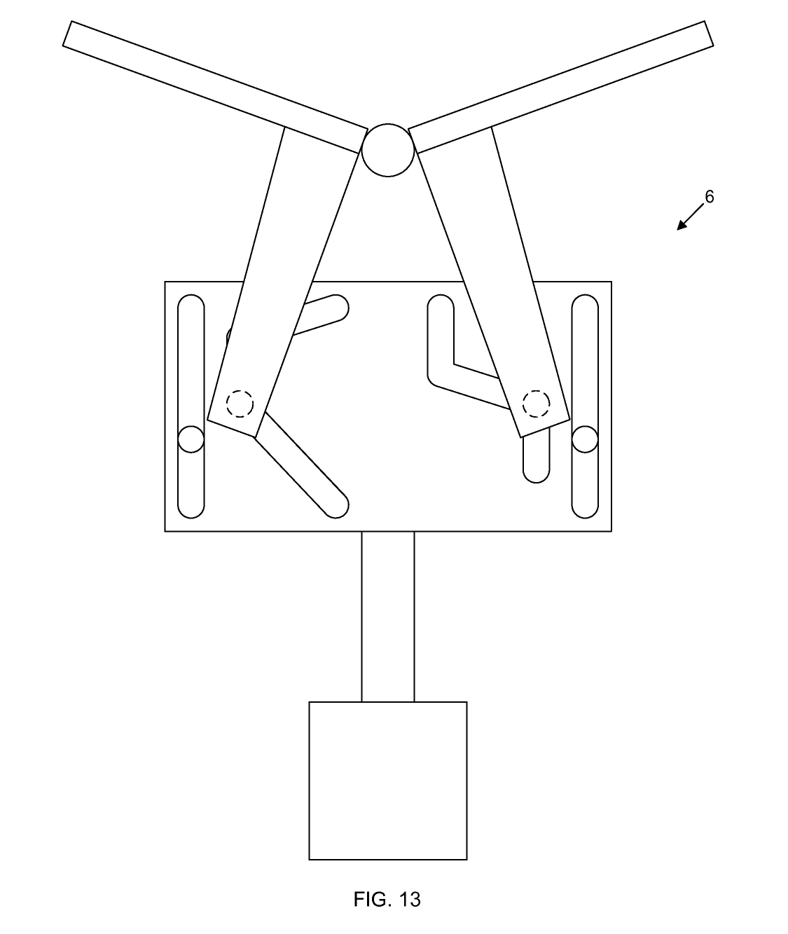

FIGS. 11 through 14 represent the door system 6 according to the second possible embodiment in a successive sequence of possible door system states. FIG. 11 represents an in-flight condition where it is desirable for the actuator system 20 to place the door system 6 in a state that has the first door 14 closed and the second door 16 closed to close the inlet 4. In this case, the actuator 30 fully retracts to make the cam plate 32 close both the first door 14 and the second door 16. FIG. 12 represents an in-flight condition where it is desirable for the actuator system 20 to place the door system 6 in a state that has the first door 14 opened and the second door 16 closed. In this case, the actuator 30 extends slightly to make the cam plate 32 open the first door 14 whilst leaving the second door 16 closed.

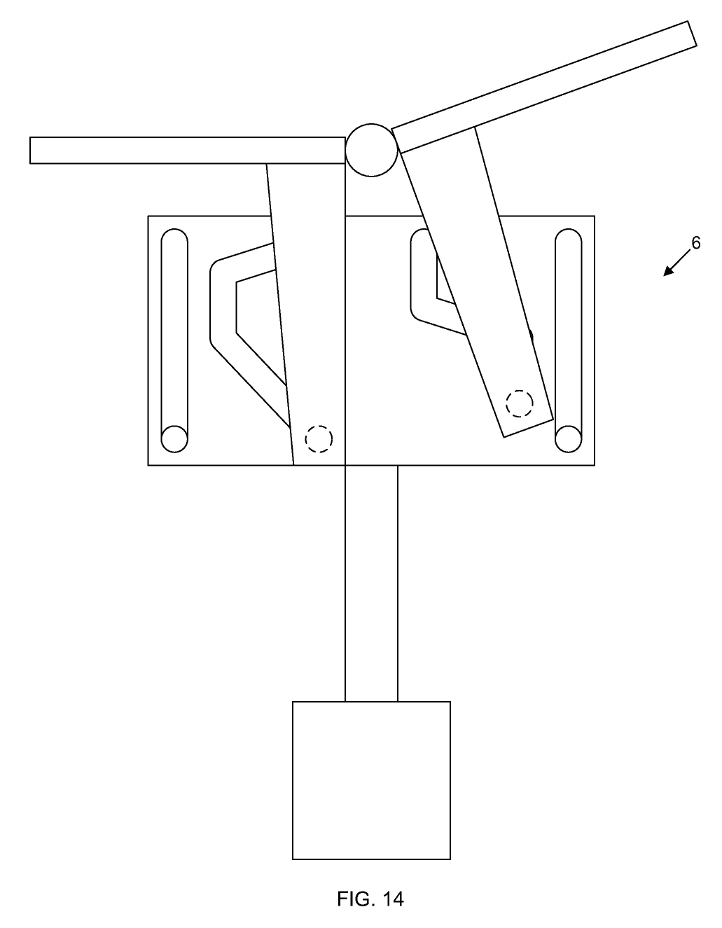

FIG. 13 represents a transition condition where it is desirable for the actuator system 20 to transition the door system 6 from a state with the first door 14 opened and the second door 16 closed to a state with the first door 14 closed and the second door 16 opened without blocking the inlet 4. In this case, the actuator 30 extends a bit more to make the cam plate 32 open the second door 16 whilst leaving the first door 14 opened. FIG. 14 represents an on-ground condition where it is desirable for the actuator system 20 to place the door system 6 in a state that has the first door 14 opened and second door 16 closed. In this case, the actuator 30 extends a bit more to make the cam plate 32 close the first door 14 whilst leaving the second door 16 opened.

The cam plate 32 limits the travel of the actuator 20 in the second embodiment so that compared to the first embodiment the degree of opening possible for the first door 14 and the second door 16 as well as the number of selectable states of the door system 6. For instance,

FIGS. 11 through 14 show maximum door openings of approximately twenty degrees with four possible selectable states of the door system 6.

FIG. 15 is a detailed side view of the door system 6 according to a third possible embodiment and FIG. 20 is a detailed end view of the third possible embodiment. It includes the first door 14 and the second door 16 both hinged by the hinge 18 and operated by the actuator system 20. However, referring to FIGS. 15 through 17 and 20 together, in this possible embodiment a first cam plate 46 that carries a first cam track 48 couples to the first door 14 and a second cam plate 50 that carries a second cam track 52 couples to the second door 16. Referring to FIGS. 15 and 18 through 20 together, a single actuator 54 that operates generally normal to the inlet plane 8 couples to a first cam follower 56 that follows the first cam track 48 in the first cam plate 46 and a second cam follower 58 that couples to the second cam track 52 in the second cam plate 50.

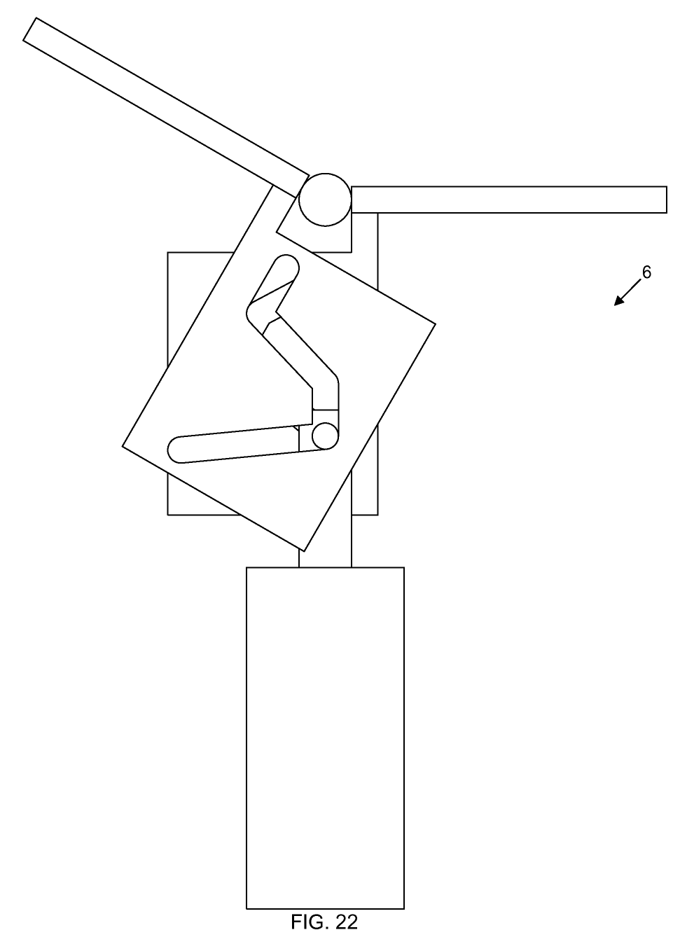

FIGS. 21 through 25 represent the door system 6 according to the third possible embodiment in a successive sequence of possible door system states. FIG. 21 represents an in-flight condition where it is desirable for the actuator system 20 to place the door system 6 in a state that has the first door 14 closed and the second door 16 closed to close the inlet 4. In this case, the actuator 54 fully retracts to make the first cam plate 46 close the first door 14 and the second cam plate 52 close the second door 16. FIG. 22 represents an in-flight condition where it is desirable for the actuator system 20 to place the door system 6 in a state that has the first door 14 opened and the second door 16 closed. In this case, the actuator 54 extends slightly to make the first cam plate 46 open the first door 14 whilst it makes the second cam plate 50 leave the second door 16 closed.

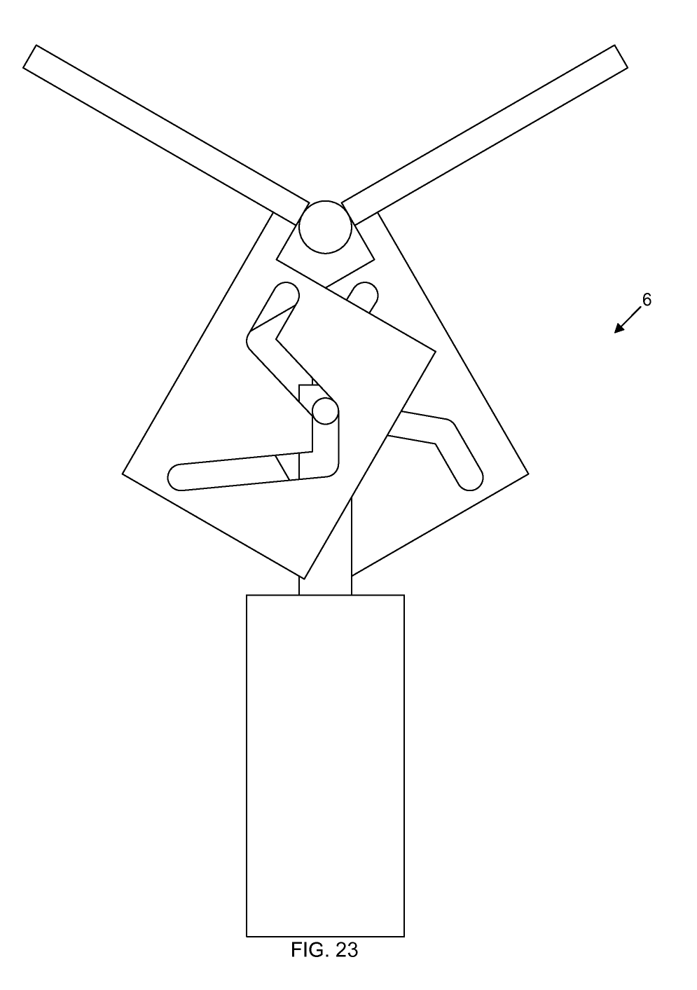

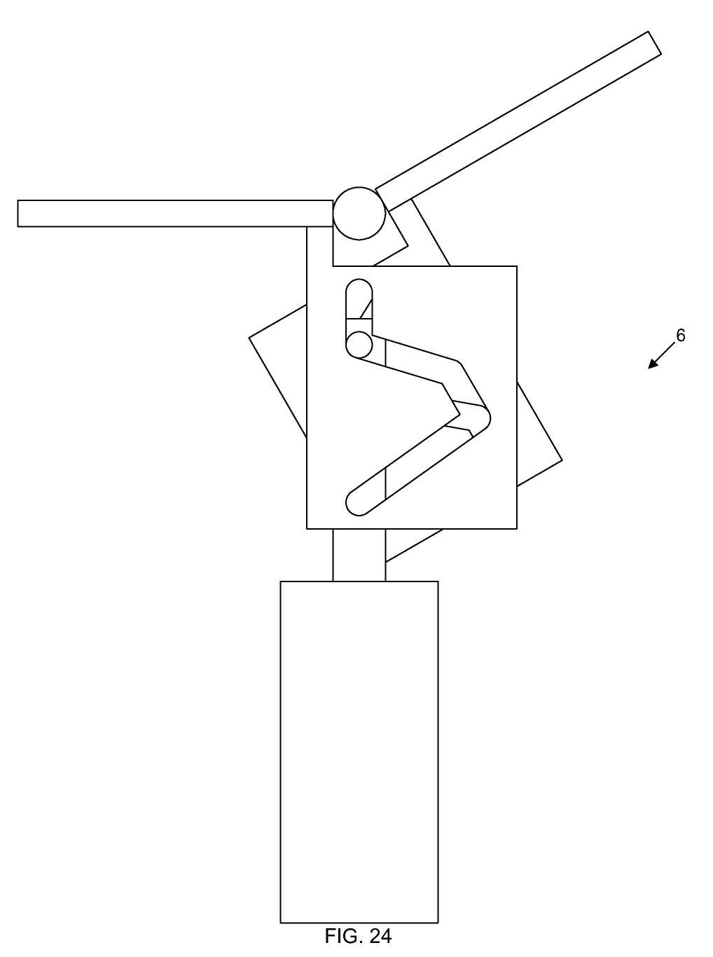

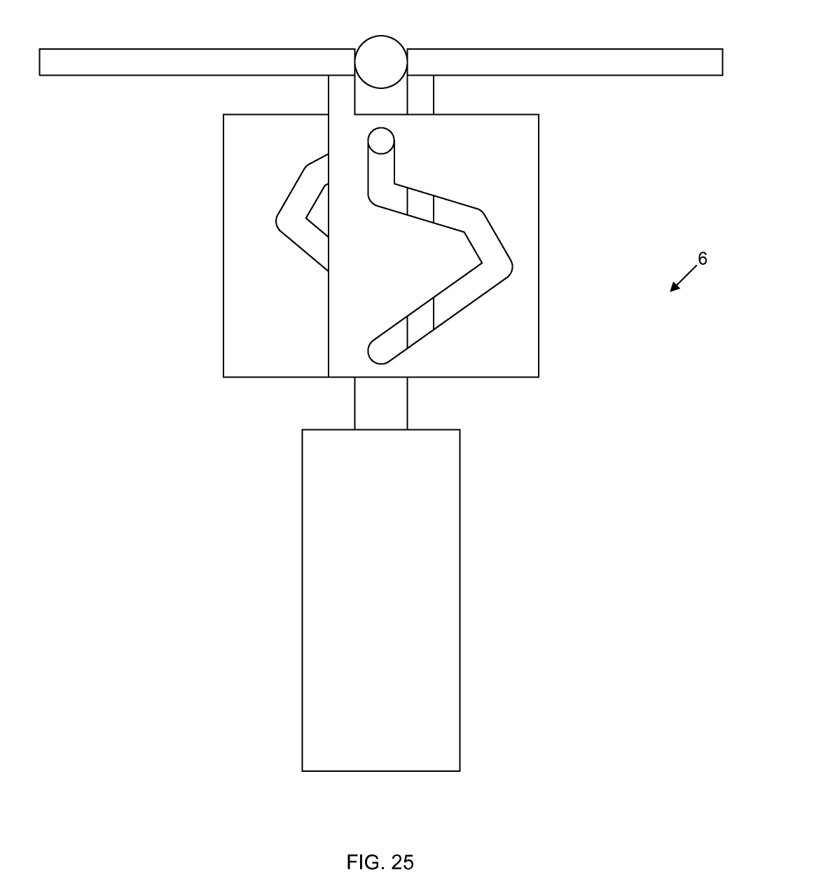

FIG. 23 represents a transition condition where it is desirable for the actuator system 20 to transition the door system 6 from a state with the first door 14 opened and the second door 16 closed to a state with the first door 14 closed and the second door 16 opened without blocking the inlet 4. In this case, the actuator 54 extends a bit more to make the first cam plate 46 leave the first door 14 opened whilst it makes the second cam plate 50 open the second door 16. FIG. 24 represents an on-ground condition where it is desirable for the actuator system 20 to place the door system 6 in a state that has the first door 14 opened and second door 16 closed. In this case, the actuator 54 extends a bit more to make the first cam plate 46 close the first door 14 whilst making the second cam plate 50 leave the second door 16 opened. FIG. 25 represents another on-ground condition where it is desirable for the actuator system 20 to place the door system 6 in a state that has the first door 14 closed and the second door 16 closed. In this case, the actuator 54 extends fully to make the first cam plate 46 leave the first door 14 closed whilst making the second cam plate 50 close the second door 16.

Like the first possible embodiment, the third possible embodiment allows the first door 14 and the second door 16 to operate in the described sequence of states of the door system 6 as well as its reverse with a wide degree of door opening. For instance, FIGS. 21 through 25 show the first door 14 and the second door 16 sequentially opening approximately thirty degrees, and wider degrees of opening are possible. Furthermore, the operation of the first door 14 and the second door 16 may not include the entire described sequence. For example, the door system 6 may delete the second on-ground state as shown in FIG. 25.

FIG. 26 is a detailed side view of the door system 6 according to a fourth possible embodiment and FIG. 27 is a detailed end view of the fourth possible embodiment. It includes the first door 14 with the first door lever 24 and the second door 16 with the second door lever 28 both hinged by the hinge 18 and operated by the actuator system 20. However, referring to FIGS. 26 through 29 together, in this possible embodiment a first cam plate 60 that carries a first cam track 62 and a second cam plate 64 that carries a second cam track 66 couples to a single actuator 68 that operates generally parallel to the inlet plane 8. The first door lever 24 carries a first cam follower 70 that follows the first cam track 62 in the first cam plate 60 and the second door lever 28 carries a second cam follower 72 that follows the second cam track 66 in the second cam plate 64.

FIGS. 30 through 34 represent the door system 6 according to the fourth possible embodiment in a successive sequence of possible door system states. FIG. 30 represents an in-flight condition where it is desirable for the actuator system 20 to place the door system 6 in a state that has the first door 14 closed and the second door 16 closed to close the inlet 4. In this case, the actuator 68 fully extends to make the first cam plate 60 close the first door 14 and the second cam plate 62 close the second door 16. FIG. 31 represents an in-flight condition where it is desirable for the actuator system 20 to place the door system 6 in a state that has the first door 14 opened and the second door 16 closed. In this case, the actuator 68 retracts slightly to make the first cam plate 60 open the first door 14 whilst it makes the second cam plate 64 leave the second door 16 closed.

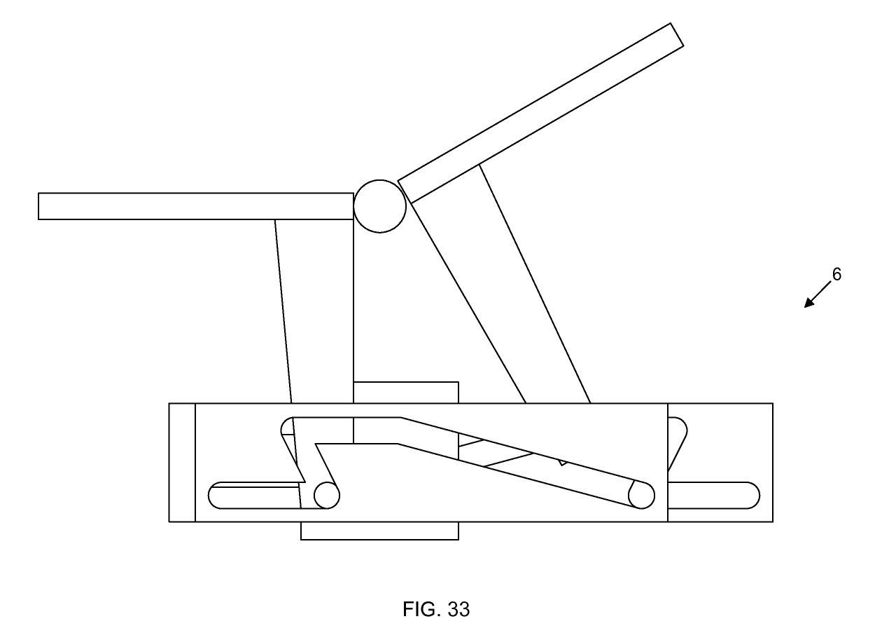

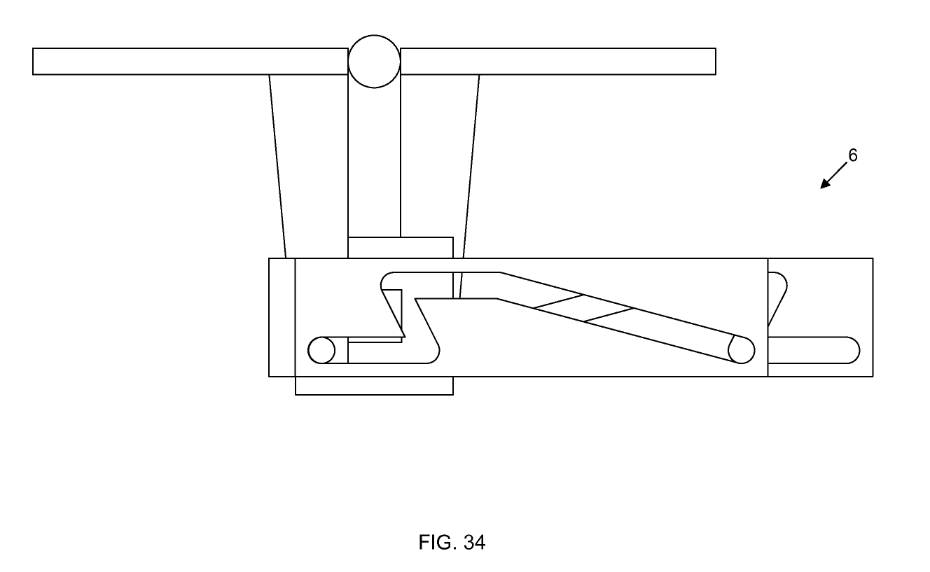

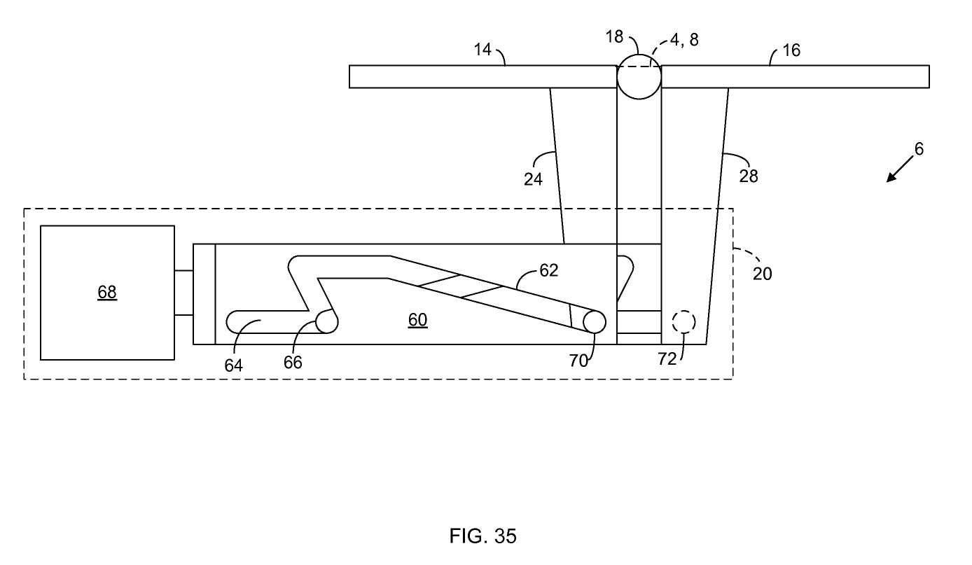

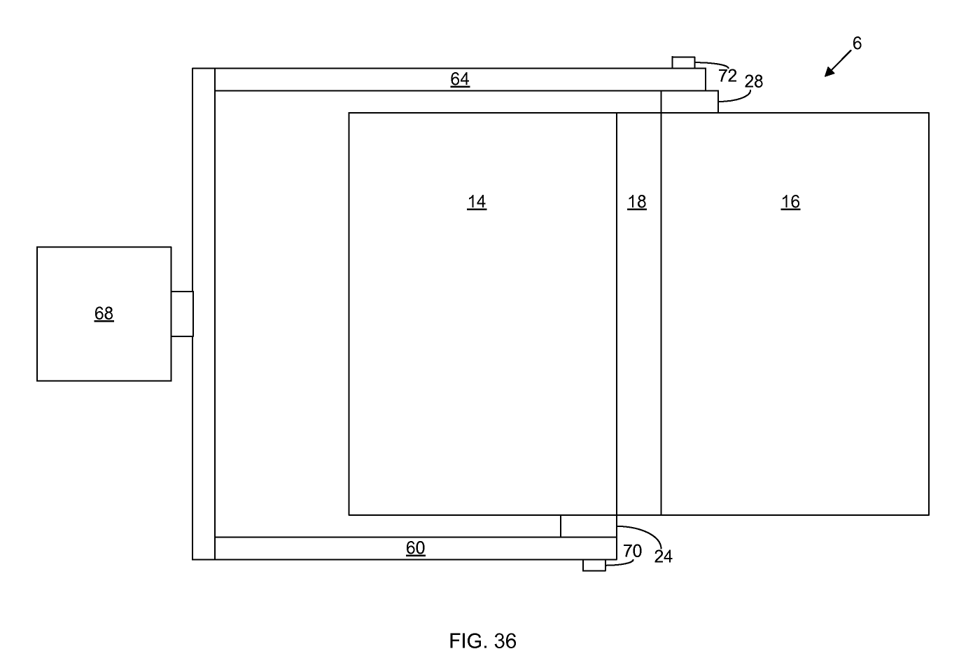

FIG. 32 represents a transition condition where it is desirable for the actuator system 20 to transition the door system 6 from a state with the first door 14 opened and the second door 16 closed to a state with the first door 14 closed and the second door 16 opened without blocking the inlet 4. In this case, the actuator 68 retracts a bit more to make the first cam plate 60 leave the first door 14 opened whilst it makes the second cam plate 64 open the second door 16. FIG. 33 represents an on-ground condition where it is desirable for the actuator system 20 to place the door system 6 in a state that has the first door 14 opened and second door 16 closed. In this case, the actuator 68 retracts a bit more to make the first cam plate 60 close the first door 14 whilst making the second cam plate 64 leave the second door 16 opened. FIG. 34 represents another on-ground condition where it is desirable for the actuator system 20 to place the door system 6 in a state that has the first door 14 closed and the second door 16 closed. In this case, the actuator 68 retracts fully to make the first cam plate 60 leave the first door 14 closed whilst making the second cam plate 64 close the second door 16.

Like the first and third possible embodiments, the fourth possible embodiment allows the first door 14 and the second door 16 to operate in the described sequence of states of the door system 6 as well as its reverse with a wide degree of door opening. For instance, FIGS. 30 through 34 show the first door 14 and the second door 16 sequentially opening approximately thirty degrees, and wider degrees of opening are possible. Furthermore, the operation of the first door 14 and the second door 16 may not include the entire described sequence. For example, the door system 6 may delete the second on-ground state as shown in FIG. 34.

FIG. 31 is a detailed side view of the door system 6 according to a fifth possible embodiment and FIG. 32 is a detailed end view of the fifth possible embodiment. It is essentially the same as the fourth possible embodiment. The only difference is that the position of the actuator 68 rotates by one hundred and eighty degrees relative to the first cam plate 60 and the second cam plate 64 so that the actuator 68 operates outside of the inlet 4. The operation of the actuator 68 is the same as described for the fourth possible embodiment, except that it extends rather than retracts to achieve comparable states of the door system 6.

Although the described embodiments refer to the application of ram air recovery aboard an aeronautical vehicle, these embodiments are also suitable for other applications that require a reversing door configuration. The described embodiments as set forth herein represents only some illustrative implementations of the invention as set forth in the attached claims. Changes and substitutions of various details and arrangement thereof are within the scope of the claimed invention.

1. A door system for an inlet, comprising:
a first door hinged to face a first direction that covers a portion of the inlet;
a second door, adjacent to the first door, hinged to face a second direction opposite the first direction that covers the remainder of the inlet; and
an actuator system that operates the doors in selectable door system states comprising: first door closed and second door closed; first door opened and second door closed; first door opened and second door opened; and first door closed and second door opened.

2. The door system of claim 1, wherein the actuator system comprises:
a first actuator that operates the first door; and
a second actuator that operates the second door.

3. The door system of claim 2, wherein the first actuator couples to the first door by way of a first door lever and the second actuator couples to the second door by way of a second door lever.

4. The door system of claim 3, wherein the inlet extends along an inlet plane and the first and second actuators operate generally parallel to the inlet plane.

5. The door system of claim 2, wherein the first and second actuators operate the first and second doors in the sequence: first door closed and second door closed; first door opened and second door closed; first door opened and second door opened; first door closed and second door opened; and the reverse of the sequence.

6. The door system of claim 2, wherein the first and second operators operate the first and second doors in the sequence: first door closed and second door closed; first door opened and second door closed; first door opened and second door opened; first door closed and second door opened; first door closed and second door closed; and the reverse of the sequence.

7. The door system of claim 1, wherein the actuator system comprises a single actuator that operates the first door and the second door.

8. The door system of claim 7, wherein the actuator couples to the first door by way of a first cam track and first cam follower and to the second door by way of a second cam track and a second cam follower.

9. The door system of claim 8, further comprising:
a cam plate coupled to the actuator that carries the first cam track and the second cam track;
a first door lever coupled to the first door that carries the first cam follower; and
a second door lever coupled to the second door that carries the second cam follower.

10. The door system of claim 9, wherein the inlet extends along an inlet plane and the actuator operates generally normal to the inlet plane.

11. The door system of claim 9, wherein the actuator operates the first and second doors in the sequence: first door closed and second door closed; first door opened and second door closed; first door opened and second door opened; first door closed and second door opened; and the reverse of the sequence.

12. The door system of claim 8, further comprising;
a first cam plate coupled to the first door that carries the first cam track; and
a second cam plate coupled to the second door that carries the second cam track;
wherein the first and second cam followers couple to the actuator.

13. The door system of claim 12, wherein the inlet extends along an inlet plane and the actuator operates generally normal to the inlet plane.

14. The door system of claim 12, wherein the actuator operates the first and second doors in the sequence: first door closed and second door closed; first door opened and second door closed; first door opened and second door opened; first door closed and second door opened; first door closed and second door closed; and the reverse of the sequence.

15. The door system of claim 8, further comprising:
a first cam plate coupled to the actuator that carries the first cam track;
a second cam plate coupled to the actuator that carries the second cam track;
a first door lever coupled to the first door that carries the first cam follower; and
a second door lever coupled to the second door that carries the second cam follower.

16. The door system of claim 15, wherein the inlet extends along an inlet plane and the actuator operates generally parallel to the inlet plane.

17. The door system of claim 15, wherein the actuator operates the first and second doors in the sequence: first door closed and second door closed; first door opened and second door closed; first door opened and second door opened; first door closed and second door opened; first door closed and second door closed; and the reverse of the sequence.

18. A method of controlling flow through an inlet for an aeronautical vehicle with a first door hinged to face a first direction that covers a portion of the inlet and a second door, adjacent to the first door, hinged to face a second direction opposite the first direction that covers the remainder of the inlet, comprising the steps of:
keeping the first and second doors closed when the aeronautical vehicle is in flight to cut off flow through the inlet;
opening the first door whilst keeping the second door closed when the aeronautical vehicle is in flight to permit normal flow through the inlet;
opening the second door whilst keeping the first door opened for establishing a transition of flow through the inlet; and
closing the first door whilst keeping the second door opened when the aeronautical vehicle is on the ground to permit normal flow through the inlet.

19. The method of claim 18, further comprising the step of closing the second door whilst keeping the first door closed when the aeronautical vehicle is on the ground cut off flow through the inlet.

20. The method of claim 18, wherein the steps follow each other in a sequence and its reverse.
